(19) United States
(12) Patent Application Publication
(10) Pub. No.: US 2026/0186995 A1
(43) Pub. Date: Jul. 2, 2026

(54) METHOD AND MEMORY SYSTEM FOR PROCESSING DATA

(71) Applicant: REBELLIONS INC., Seongnam-si (KR)

(72) Inventors: Hyunho KIM, Seongnam-si (KR); Sangeun JE, Seongnam-si (KR); Jaewan BAE, Seongnam-si (KR)

(21) Appl. No.: 19/408,268

(22) Filed: Dec. 3, 2025

(30) Foreign Application Priority Data
Dec. 26, 2024 (KR) 10-2024-0197567

(51) Int. Cl. G06F 13/28; G06F 13/16

(52) U.S. Cl. CPC G06F 13/28; G06F 13/1673

(57) ABSTRACT

The present disclosure relates to a data processing method performed by a direct memory access (DMA) controller. The data processing method includes receiving a task associated with an operation of converting source data stored in a first data structure in a memory device connected to the DMA controller into destination data having a second data structure different from the first data structure, defining, based on a first burst length associated with the source data and a second burst length associated with the destination data, a structure of a plurality of sub-data sets into which the source data is divided, and issuing a read request for the source data in units of the first burst length based on the defined structure of the plurality of sub-data sets.

### CROSS-REFERENCE TO RELATED APPLICATION

The present application claims priority to and the benefit of Korean Application No. 10-2024-0197567, filed on December 26, 2024, in the Korean Intellectual Property Office, the entire disclosure of which is incorporated by reference herein.

### BACKGROUND

### FIELD

The present disclosure relates to a data processing method and a memory system, and specifically, to a method and a memory system for defining a structure of a plurality of sub-data sets obtained by dividing source data based on a burst length associated with the source data and a burst length associated with destination data in order to convert a data structure of the source data into a data structure of the destination data, and issuing a read request and/or a write request for the source data based on the defined structure of the plurality of sub-data sets.

### DESCRIPTION OF THE RELATED ART

A direct memory access (DMA) controller minimizes a data input/output control operation of a central processing unit (CPU) for a memory device and may directly control data access and movement.

Meanwhile, the DMA controller may control a tensor permutation operation that converts a data structure of data stored in the memory device in order to implement a data access pattern optimized for a bus architecture of a System on Chip (SoC). The tensor permutation may include a task of rearranging an order of axes of data of a multi-dimensional array to make a specific operation or a data access pattern efficient. However, in a case of a conventional tensor

permutation operation, because the conventional tensor permutation operation is mainly optimized for a CPU-based or GPU-based operation, there is a problem that a bandwidth of a bus is not utilized efficiently.

Therefore, an introduction of a data processing method and a memory system for efficiently controlling a tensor permutation operation optimized for a bus architecture of an SoC is required.

### SUMMARY

The present disclosure provides a data processing method and a memory system for solving the problems described above.

The present disclosure may be implemented in various ways, including a method, an apparatus (system), and/or a computer program stored in a computer-readable storage medium.

A data processing method performed by a direct memory access (DMA) controller according to an embodiment of the present disclosure includes receiving a task associated with an operation of converting source data stored in a first data structure in a memory device connected to the DMA controller into destination data having a second data structure different from the first data structure, defining, based on a first burst length associated with the source data and a second burst length associated with the destination data, a structure of a plurality of sub-data sets into which the source data is divided, and issuing a read request for the source data in units of the first burst length based on the defined structure of the plurality of sub-data sets.

In an embodiment of the present disclosure, each of the source data and the destination data is a tensor including a plurality of data units of a multi-dimensional array, and a plurality of data units included in the source data having the first data structure and a plurality of data units included in the destination data having the second data structure have different axis arrangements.

In an embodiment of the present disclosure, the plurality of data units included in the source data are processed in units of the first burst length, and the plurality of data units included in the destination data are processed in units of the second burst length.

In an embodiment of the present disclosure, each of the plurality of sub-data sets includes a plurality of data units arranged along a direction of a first axis of the tensor and a direction of a second axis of the tensor, a length of each of the plurality of sub-data sets in the direction of the first axis is determined to be greater than or equal to the first burst length, and a length of each of the plurality of sub-data sets in the direction of the second axis is determined to be greater than or equal to the second burst length.

In an embodiment of the present disclosure, the length of each of the plurality of sub-data sets in the direction of the first axis is determined as a multiple of the first burst length, and the length of each of the plurality of sub-data sets in the direction of the second axis is determined as a multiple of the second burst length.

In an embodiment of the present disclosure, the DMA controller includes a plurality of buffer groups, each of the plurality of buffer groups includes a plurality of buffers, and the method further includes receiving, based on the issued read request and from the memory device, the plurality of sub-data sets into which the source data is divided, and storing the received plurality of sub-data sets in each of the plurality of buffer groups.

In an embodiment of the present disclosure, the method further includes writing the plurality of sub-data sets stored in each of the plurality of buffer groups to the memory device as the destination data having the second data structure.

In an embodiment of the present disclosure, the storing includes storing each of a plurality of data units included in a first sub-data set in a plurality of buffers included in a first buffer group, and the writing includes issuing a write request for recording the plurality of data units stored in each of the plurality of buffers included in the first buffer group into the second data structure.

In an embodiment of the present disclosure, the storing in the plurality of buffers includes identifying an index of each of the plurality of buffers for storing each of the plurality of data units included in the first sub-data set, and storing, based on the identified index of each of the plurality of buffers, the plurality of data units included in the first sub-data set in the first buffer group, wherein the issuing includes issuing the write request in units of the second burst length for the plurality of data units stored in the first buffer group, and the identified index of each of the plurality of buffers is associated with an order of the plurality of data units for which the write request is issued.

In an embodiment of the present disclosure, the storing in the plurality of buffers includes sequentially storing each of the plurality of data units included in the first sub-data set in the plurality of buffers, and the issuing includes identifying an index of each of the plurality of buffers in which each of a plurality of data units for issuing the write request is stored with respect to the first buffer group, and issuing, based on the identified index of each of the plurality of buffers, the write request for the plurality of data units stored in the first buffer group.

In an embodiment of the present disclosure, the issuing includes determining whether the plurality of data units included in the first sub-data set have been completely stored in the first buffer group, and issuing the write request for the plurality of data units stored in the first buffer group in response to determining that the plurality of data units included in the first sub-data set have been completely stored in the first buffer group.

In an embodiment of the present disclosure, each of the plurality of buffer groups is connected to the memory device through a plurality of channels, and the receiving includes receiving the first sub-data set through a first channel, and receiving a second sub-data set through a second channel.

In an embodiment of the present disclosure, the source data is stored in a specific region of the memory device, the specific region includes a boundary of a period of the first burst length, and the defining includes identifying a base address of the specific region in which the source data is stored, determining whether the identified base address is aligned with the boundary, and defining a structure of a first sub-data set in response to determining that the identified base address is not aligned with the boundary, wherein the first sub-data set is a sub-data set associated with a read request issued first among the plurality of sub-data sets.

In an embodiment of the present disclosure, the source data is stored in a specific region of the memory device, the specific region includes a boundary of a period of the first burst length, and the defining includes determining whether a number of the plurality of data units arranged in the direction of the first axis of the source data is a multiple of the first burst length, and in response to determining that the number of the plurality of data units arranged in the direction of the first axis is not a multiple of the first burst length, defining the structure of the plurality of sub-data sets such that a number of boundaries included within each of the plurality of sub-data sets is minimized.

A memory system according to an embodiment of the present disclosure includes a DMA controller including a plurality of buffer groups, and a memory device connected to the plurality of buffer groups through a plurality of channels, wherein the DMA controller is configured to receive a task associated with an operation of converting source data stored in a first data structure in the memory device into destination data having a second data structure different from the first data structure, define, based on a first burst length associated with the source data and a second burst length associated with the destination data, a structure of a plurality of sub-data sets into which the source data is divided, and issue, based on the defined structure of the plurality of sub-data sets, a read request for the source data in units of the first burst length.

In an embodiment of the present disclosure, each of the source data and the destination data is a tensor including a plurality of data units of a multi-dimensional array, a plurality of data units included in the source data having the first data structure and a plurality of data units included in the destination data having the second data structure have different axis arrangements, and the DMA controller is further configured to process the plurality of data units included in the source data in units of the first burst length, and process the plurality of data units included in the destination data in units of the second burst length.

In an embodiment of the present disclosure, each of the plurality of sub-data sets includes a plurality of data units arranged along a direction of a first axis of the tensor and a direction of a second axis of the tensor, a length of each of the plurality of sub-data sets in the direction of the first axis is determined as a multiple of the first burst length, and a length of each of the plurality of sub-data sets in the direction of the second axis is determined as a multiple of the second burst length.

In an embodiment of the present disclosure, the DMA controller is further configured to receive, from the memory device through the plurality of channels, the plurality of sub-data sets into which the source data is divided, store the received plurality of sub-data sets in each of the plurality of buffer groups, and write the plurality of sub-data sets stored in each of the plurality of buffer groups to the memory device as the destination data having the second data structure.

In an embodiment of the present disclosure, each of the plurality of buffer groups includes a plurality of buffers, and the DMA controller is further configured to store each of a plurality of data units included in a first sub-data set in the plurality of buffers included in a first buffer group, and issue a write request for recording the plurality of data units stored in each of the plurality of buffers included in the first buffer group into the second data structure.

In an embodiment of the present disclosure, the DMA controller is further configured to identify an index of each of the plurality of buffers for storing each of the plurality of data units included in the first sub-data set, store, based on the identified index of each of the plurality of buffers, the plurality of data units included in the first sub-data set in the first buffer group, and issue the write request in units of the second burst length for the plurality of data units stored in the first buffer group, wherein the identified index of each of the plurality of buffers is associated with an order of the plurality of data units for which the write request is issued.

According to some embodiments of the present disclosure, the DMA controller issues a read request in units of a burst length optimized for the source data for the plurality of sub-data sets obtained by dividing the source data, thereby effectively utilizing a bandwidth of the memory device required for reading the source data.

According to some embodiments of the present disclosure, the DMA controller stores the sub-data set in a buffer so that a write request in units of a burst length optimized for the destination data may be continuously issued, thereby preventing the bandwidth of the memory device from being inefficiently used due to frequent memory access of a short burst length.

According to some embodiments of the present disclosure, as the length of the first sub-data set in the direction of the first axis is determined as the first burst length and the length in the direction of the second axis is determined as the second burst length, a length and/or a frequency of the read request and the write request for the plurality of data units included in the first sub-data set may be optimized.

The effects of the present disclosure are not limited to the effects mentioned above, and other effects not mentioned may be clearly understood by those of ordinary skill in the art to which the present disclosure pertains (referred to as "those skilled in the art") from the description of the claims.

### BRIEF DESCRIPTION OF THE DRAWINGS

Embodiments of the present disclosure will be described with reference to the accompanying drawings described below, wherein like reference numbers indicate like elements, but are not limited thereto.

FIG. 1 illustrates an operation of a direct memory access (DMA) controller according to an embodiment of the present disclosure.

FIG. 2 illustrates an example of an operation in which a data structure of source data is converted.

FIG. 3 is a diagram illustrating an example of source data having a first data structure.

FIG. 4 is a diagram illustrating an example of destination data having a second data structure.

FIG. 5 illustrates an example in which a structure of a sub-data set is defined according to an embodiment of the present disclosure.

FIG. 6 illustrates an example in which a read request is issued based on a structure of a sub-data set according to an embodiment of the present disclosure.

FIG. 7 illustrates an example in which a sub-data set is stored in a buffer group and then written as destination data according to an embodiment of the present disclosure.

FIG. 8 illustrates an example in which a sub-data set is stored in a buffer group and then written as destination data according to another embodiment of the present disclosure.

FIG. 9 is a diagram illustrating a memory system including a DMA controller according to an embodiment of the present disclosure.

FIG. 10 illustrates an example in which a structure of a first sub-data set is defined.

FIG. 11 illustrates an example in which a structure of a sub-data set is defined according to another embodiment of the present disclosure.

FIG. 12 is a flowchart illustrating a data processing method according to an embodiment of the present disclosure.

### DETAILED DESCRIPTION

Hereinafter, detailed contents for carrying out the present disclosure will be described in detail with reference to the accompanying drawings. However, in the following description, if there is a concern that the gist of the present disclosure may be unnecessarily obscured, detailed descriptions of widely known functions or configurations will be omitted.

In the accompanying drawings, identical or corresponding components are given identical reference numbers. Also, in the description of the following embodiments, duplicate descriptions of identical or corresponding components may be omitted. However, even if a description of a component is omitted, it is not intended that such a component is not included in any embodiment.

Advantages and features of the disclosed embodiments, and methods of achieving them, will become apparent with reference to the embodiments described below in conjunction with the accompanying drawings. However, the present disclosure is not limited to the embodiments disclosed below, but may be implemented in various different forms, and these embodiments are provided only to make the present disclosure complete and to completely inform those skilled in the art of the scope of the invention.

Terms used in the present specification will be briefly described, and the disclosed embodiments will be described in detail. As terms used in the present specification, general terms currently widely used as possible are selected while considering functions in the present disclosure, but these may vary depending on intentions of technicians working in the related field or precedents, emergence of new technologies, etc. Also, in specific cases, there are terms arbitrarily selected by the applicant, and in this case, the meaning thereof will be described in detail in the description part of the corresponding invention. Therefore, the terms used in the present disclosure should be defined based on the meaning of the terms and the contents throughout the present disclosure, rather than simple names of the terms.

Singular expressions in the present specification include plural expressions unless the context clearly dictates otherwise as singular. Also, plural expressions include singular expressions unless the context clearly dictates otherwise as plural. Throughout the specification, when a part is said to include a component, this means that it may further include other components, not excluding other components unless specifically stated to the contrary.

Also, the term "module" or "unit" used in the specification means a software or hardware component, and the "module" or "unit" performs certain roles. However, the "module" or "unit" is not limited to software or hardware. The "module" or "unit" may be configured to reside in an addressable storage medium or may be configured to reproduce one or more processors. Therefore, as an example, the "module" or "unit" may include components such as software components, object-oriented software components, class components, and task components, and processes, functions, attributes, procedures, subroutines, segments of program code, drivers, firmware, microcode, circuits, data, databases, data structures, tables, arrays, or variables. Functions provided within components and "modules" or "units" may be combined into a smaller number of components and "modules" or "units" or may be further separated into additional components and "modules" or "units".

According to an embodiment of the present disclosure, the "module" or "unit" may be implemented as a processor and a memory, or may be implemented as a circuit or circuitry. Terms such as "circuit" and "circuitry" may mean a circuit on hardware, but may also mean a circuit on software. The "processor" should be interpreted broadly to include a general-purpose processor, a central processing unit (CPU), a microprocessor, a digital signal processor (DSP), a controller, a microcontroller, a state machine, etc. In some environments, the "processor" may refer to an application-specific integrated circuit (ASIC), a programmable logic device (PLD), a field programmable gate array (FPGA), etc. The "processor" may also refer to a combination of processing devices, for example, a combination of a DSP and a microprocessor, a combination of a plurality of microprocessors, a combination of one or more microprocessors in conjunction with a DSP core, or any combination of any other such configurations. Also, the "memory" should be interpreted broadly to include any electronic component capable of storing electronic information. The "memory" may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. If the processor can read information from the memory and/or write information to the memory, the memory is said to be in electronic communication with the processor. A memory integrated into the processor is in electronic communication with the processor.

Also, terms such as first, second, A, B, (a), (b), etc. used in the following embodiments are only used to distinguish a component from other components, and the essence, sequence, or order of the corresponding component is not limited by the terms.

Also, in the following embodiments, when a component is described as being "connected", "coupled", or "accessed" to another component, the component may be directly connected or accessed to the other component, but it should be understood that another component may be "connected", "coupled", or "accessed" between each component.

Also, "comprises" and/or "comprising" used in the following embodiments do not exclude the presence or addition of one or more other components, steps, operations, and/or elements for the mentioned components, steps, operations, and/or elements.

In the present disclosure, "each of a plurality of A" may refer to each of all components included in the plurality of A, or may refer to each of some components included in the plurality of A.

Prior to describing various embodiments of the present disclosure, terms used will be described.

In the present disclosure, an "address" may refer to a unique identifier indicating a location where data or information is stored. The "address" may include a physical address of hardware, and a logical address or a virtual address used in an application or an operating system, etc. The "address" may refer to an address range where specific data or information is located. Also, a "base address" may refer to a start address of an address range where corresponding data or information is located.

In the present disclosure, "source data" is data stored in a specific region of a memory device and may refer to data for which a data structure is to be converted. "Destination data" may refer to data in which the data structure of the source data has been converted. The destination data may be stored in a region different from the specific region of the memory device in which the source data is stored, or may be stored in a memory device different from the memory device in which the source data is stored.

In the present disclosure, a "burst length" may refer to a data processing unit for reading or writing data. For example, the "burst length" may refer to a unit of optimized data transmission that a DMA controller or a memory controller can process continuously with a single command.

In the present disclosure, a "boundary" may refer to a border defined based on a specific unit or an address of a location serving as a border in order to ensure efficiency of data access and processing in a process of reading, writing, or transmitting data in the memory device. For example, the "boundary" may be defined in units of a burst length.

In the present disclosure, in some usages, a "task" may refer to or include a task descriptor expressing attribute information of the task. For instance, receiving a task associated with an operation of converting the data structure of the source data may refer to or include receiving a task descriptor including information on the data structure of the source data and information on a data structure of the destination data.

Hereinafter, various embodiments of the present disclosure will be described in detail according to the accompanying drawings.

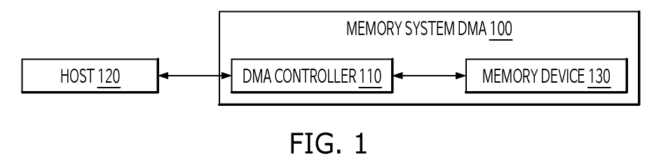

FIG. 1 illustrates an operation of a direct memory access (DMA) controller 110 according to an embodiment of the present disclosure. As illustrated, the DMA controller 110 may be connected to a memory device 130. The DMA controller 110 may manage data transmission with the memory device 130 to write data to the memory device 130 or read data stored in the memory device 130. As illustrated in FIG. 1, the DMA controller 110 and the memory device 130 may be included in a memory system 100.

In an embodiment, the DMA controller 110 may control transmission of data without data input/output control of a host 120 (e.g., a CPU). For example, the DMA controller 110 may acquire control authority of a system bus from the host 120 and directly manage data transmission between the memory device 130 and the DMA controller 110 and/or data transmission between the memory device 130 and a separate peripheral device (e.g., an input/output device).

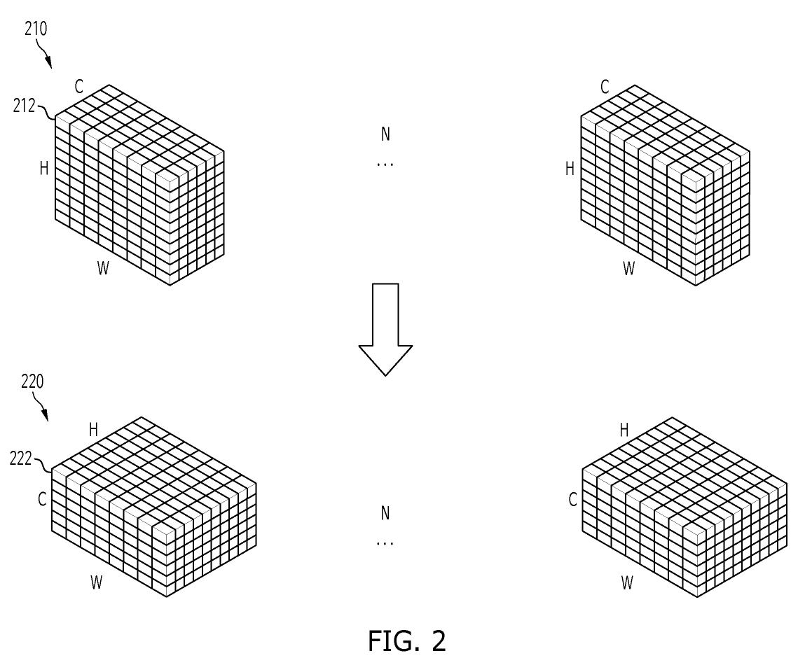

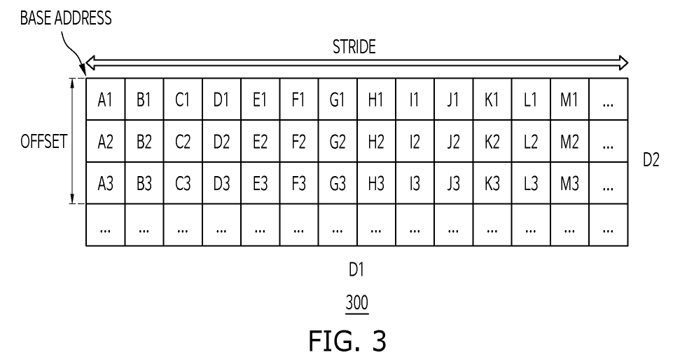

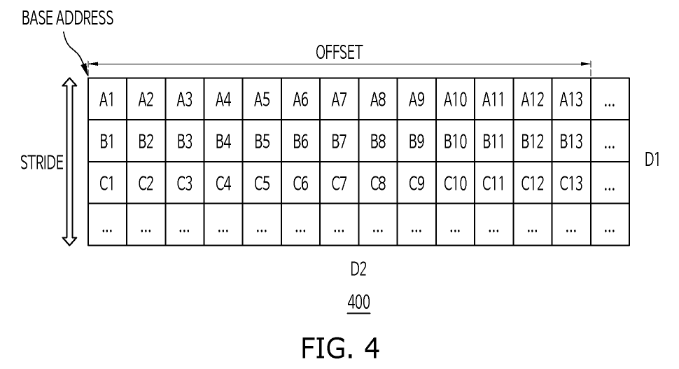

The DMA controller 110 may receive source data stored in a specific region of the memory device 130 and convert a data structure of the received source data. As an example, the DMA controller 110 may convert source data having a first data structure into destination data having a second data structure. An example of converting the data structure of the source data will be described later with reference to FIG. 2. Also, examples of the source data having the first data structure and the destination data having the second data structure will be described later with reference to FIGS. 3 and 4.

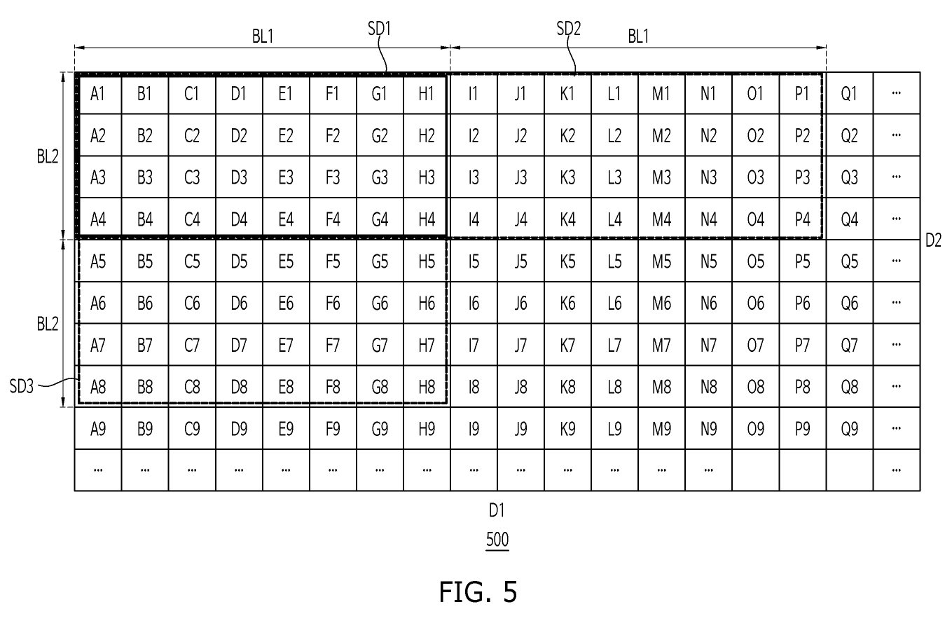

The DMA controller 110 may define a structure of a plurality of sub-data sets for dividing the source data in order to convert the data structure of the source data received from the memory device 130. The DMA controller 110 may receive the plurality of sub-data sets through each of a plurality of channels connected to the memory device 130. Examples in which the structure of the plurality of sub-data sets is defined will be described later with reference to FIGS. 5, 10, and 11.

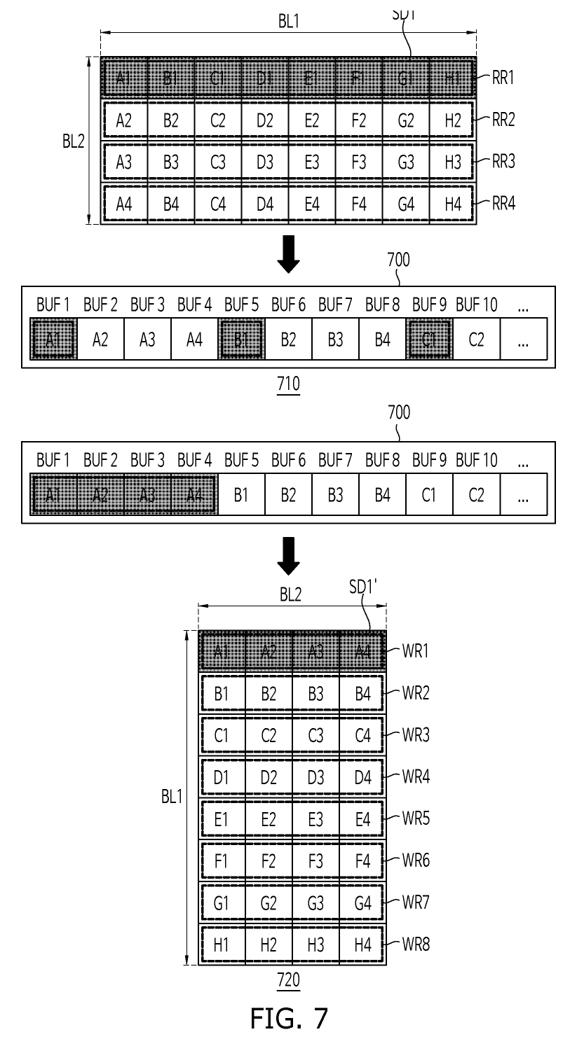

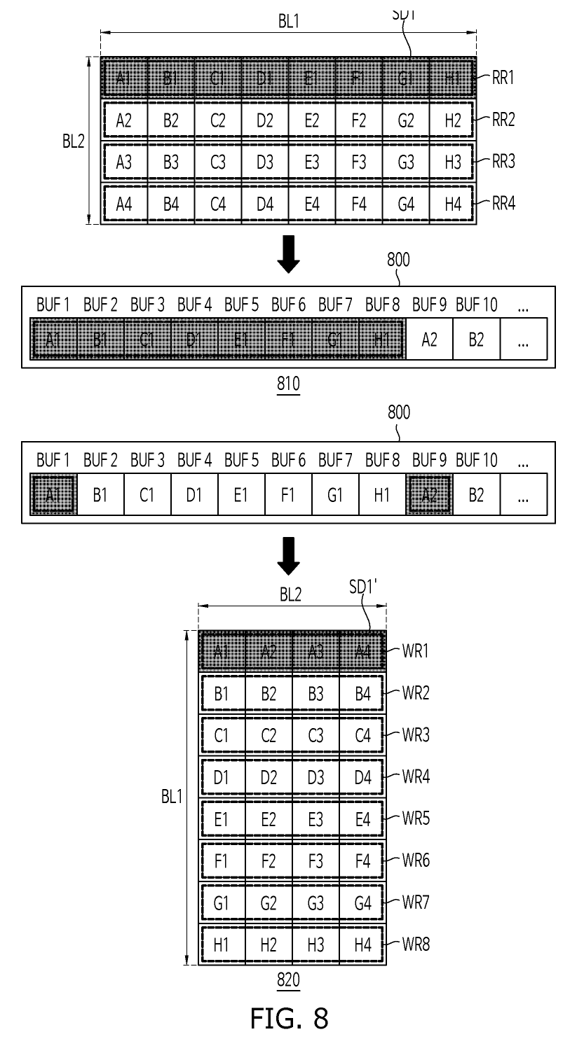

The DMA controller 110 may store the plurality of sub-data sets received from the memory device 130 in a plurality of buffer groups included in the DMA controller 110. The plurality of sub-data sets stored in the plurality of buffer groups may be written to the memory device 130 as destination data having a data structure different from the source data. A specific example thereof will be described later with reference to FIGS. 7 and 8.

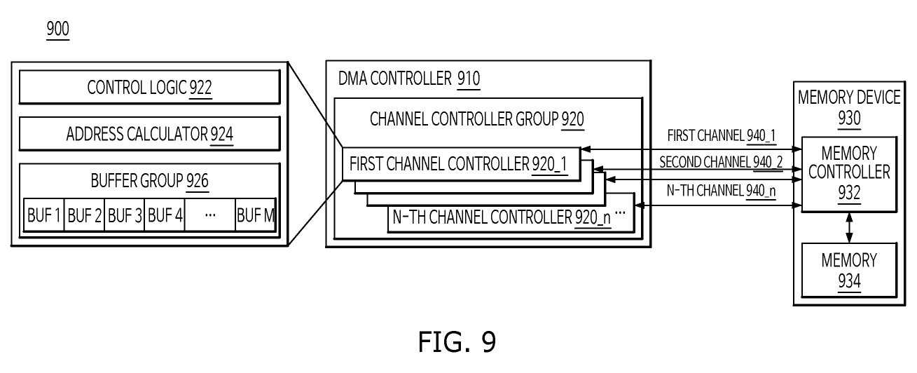

The DMA controller 110 may be connected to the memory device 130 through a plurality of channels. For example, each of the plurality of buffer groups included in the DMA controller 110 may transmit and receive data to and from the memory device 130 through the plurality of channels. A specific configuration of the DMA controller 110 and a specific operation of each configuration will be described later with reference to FIG. 9.

FIG. 2 illustrates an example of an operation in which a data structure of source data 210 is converted. The operation of converting the data structure may be performed by a DMA controller (e.g., the DMA controller 110 of FIG. 1). The DMA controller may convert the data structure. For example, the DMA controller may convert the data structure of the source data 210 stored in a specific region of the memory device in a first data structure, and write it as destination data 220 having a second data structure in another region of the memory device.

In an embodiment, the source data 210 may be a tensor having a multi-dimensional array. For example, the source data 210 may have a structure in which a plurality of data units 212 are multi-dimensionally arranged along a plurality of axes. As a specific example, the plurality of data units 212 included in the source data 210 may have a data structure (e.g., the first data structure) sequentially arranged along four axes of a W axis, an H axis, a C axis, and an N axis. Each of the plurality of data units may have a size of 128 bytes, but is not limited thereto.

In FIG. 2, the plurality of data units 212 included in the source data 210 are illustrated as being arranged along four axes, but are not limited thereto. For example, the source data 210 may be a set of a plurality of data units 212 arranged along two or more axes.

In an embodiment, the destination data 220 may be a tensor having an axis arrangement different from the source data 210. For example, the destination data 220 may have a structure in which a plurality of data units 222 are multi-dimensionally arranged along a plurality of axes so as to have an axis arrangement different from the source data 210.

In an embodiment, a configuration of each of the plurality of data units 212 included in the source data 210 and the plurality of data units 222 included in the destination data 220 is identical, but arrangements thereof may be different. As a specific example, the plurality of data units 222 included in the destination data 220 may have a data structure (e.g., the second data structure) sequentially arranged along four axes of the W axis, the C axis, the H axis, and the N axis.

In other words, the destination data 220 may be data generated through tensor permutation for the source data 210 so as to have an axis arrangement different from each other with the source data 210. As the source data 210 and the destination data 220 have different axis arrangements, an order in which the plurality of data units 212 included in the source data 210 and the plurality of data units 222 included in the destination data 220 are arranged may be different.

Hereinafter, a method for optimizing an operation for converting the source data 210 having the first data structure into the destination data 220 having the second data structure will be described.

FIG. 3 is a diagram illustrating an example of source data 300 having a first data structure, and FIG. 4 is a diagram illustrating an example of destination data 400 having a second data structure.

Referring to FIG. 3, the source data 300 may be an array of a plurality of data units having a first axis D1 and a second axis D2. The first axis D1 and the second axis D2 may be arbitrary two axes among a plurality of axes (e.g., the W axis, the H axis, the C axis, and the N axis of the source data 210 of FIG. 2) included in the source data 300.

As an example, the source data 300 may have an Array of Structures (AoS) structure. The source data 300 may be arranged, from a base address where a first data unit of the source data 300 is located, by attribute in a horizontal direction (e.g., a direction of the first axis D1) and by component of a corresponding attribute in a vertical direction (e.g., a direction of the second axis D2).

Explaining with the illustrated example, a plurality of data units included in the source data 300 may be arranged in the direction of the first axis D1 in an order of attributes A, B, C, D, E, and F based on the base address, and may be arranged in the direction of the second axis D2 in an order of components A1, A2, A3, and A4 for each attribute, for example, in attribute A. In other words, the plurality of data units included in the source data 300 may have a row-major arrangement.

An offset may refer to a distance (e.g., in byte units) that a specific data unit is separated from the base address along an axis direction. For example, assuming an interval between each data unit is 1, an offset of data unit A2 may be 1 from the base address, and an offset of data unit A3 may be 2 from the base address.

As an example, a DMA controller (e.g., the DMA controller 110 of FIG. 1) may process data in the horizontal direction (e.g., the direction of the first axis D1) for the plurality of data units included in the source data 300. At this time, a stride of the source data 300 may refer to a number of data units included in an axis in the horizontal direction (the first axis D1) of the source data 300 or a length (e.g., in byte units) of the first axis D1. For example, the stride of the source data 300 may mean a distance to move to access a data unit (e.g., A2) of a corresponding attribute in a next row from a data unit (e.g., A1) of a specific attribute in a specific row of the source data 300.

Referring to FIG. 4, the destination data 400 may be an array of a plurality of data units having the first axis D1 and the second axis D2. The destination data 400 may have an axis arrangement different from the source data 300.

As an example, the destination data 400 may have a Structure of Arrays (SoA) structure. The destination data 400 may be arranged by component in the horizontal direction (e.g., the direction of the second axis D2) and by attribute in the vertical direction (e.g., the direction of the first axis D1) from a base address where a first data unit of the destination data 400 is located. In other words, a plurality of data units included in the destination data 400 may have a column-major arrangement.

As an example, the DMA controller may process data in the vertical direction (e.g., the direction of the first axis D1) for the plurality of data units included in the destination data 400. At this time, a stride of the destination data 400 may refer to a number of data units included in an axis in the vertical direction (e.g., the first axis D1) of the destination data 400 or a length (e.g., in byte units) of the first axis D1.

Referring to FIGS. 3 and 4, an axis arrangement of the plurality of data units included in the source data 300 and an axis arrangement of the plurality of data units included in the destination data 400 may be different according to a direction in which the plurality of data units included in each of the source data 300 and the destination data 400 are processed. The axis arrangement of the source data 300 having the first data structure may be converted into the axis arrangement of the destination data 400 having the second data structure by the DMA controller.

FIG. 5 illustrates an example in which a structure of a sub-data set SD1 is defined according to an embodiment of the present disclosure. A DMA controller (e.g., the DMA controller 110 of FIG. 1) may define a structure of a plurality of sub-data sets for dividing source data 500 in order to convert a data structure of the source data 500. Additionally or alternatively, the structure of the plurality of sub-data sets may be determined by a host (e.g., the host 120 of FIG. 1) and provided to the DMA controller.

The structure of the plurality of sub-data sets may be defined based on a first burst length BL1 associated with the source data 500 and a second burst length BL2 associated with destination data. Here, a burst length may refer to a number of data units or a size of data continuously transmitted by a single read/write operation. The burst length may be determined based on a location within a memory device (e.g., the memory device 130 of FIG. 1) where data is stored and/or a structure of the memory device. For example, the source data 500 stored in a first region of the memory device may be read in units of the first burst length BL1, and data for the destination data to be stored in a second region of the memory device may be written in units of the second burst length BL2.

In an embodiment, each of the plurality of sub-data sets may include a plurality of data units arranged along a direction of the first axis D1 and a direction of the second axis D2 of the source data 500. At this time, a length of each of the plurality of sub-data sets in the direction of the first axis D1 may be determined as the first burst length BL1, and a length in the direction of the second axis D2 may be determined as the second burst length BL2. Explaining with the illustrated example, when the first burst length BL1 is 8 and the second burst length BL2 is 4, the sub-data set SD1 may have a length of 8 data units in the direction of the first axis D1 and a length of 4 data units in the direction of the second axis D2. In this case, the sub-data set SD1 may include 32 (e.g., 8 X 4 = 32) data units.

In another embodiment, the length of each of the plurality of sub-data sets in the direction of the first axis D1 may be determined to be greater than or equal to the first burst length BL1, and the length in the direction of the second axis D2 may be determined to be greater than or equal to the second burst length BL2. For instance, the length of each of the plurality of sub-data sets in the direction of the first axis D1 may be determined as a multiple of the first burst length BL1, and the length in the direction of the second axis D2 may be determined as a multiple of the second burst length BL2.

As a specific example, a sub-data set SD2 may have a length of 16 data units, which is twice the first burst length BL1, in the direction of the first axis D1, and a length of 4 data units, which is the second burst length BL2, in the direction of the second axis D2. As another example, a sub-data set SD3 may have a length of 8 data units, which is the first burst length BL1, in the direction of the first axis D1, and a length of 8 data units, which is twice the second burst length BL2, in the direction of the second axis D2.

Each of the plurality of sub-data sets may be stored in a plurality of buffer groups. The structure and/or size of the plurality of sub-data sets is not limited to what is illustrated, and may be changed based on a capacity of a buffer group in which each of the plurality of sub-data sets is stored.

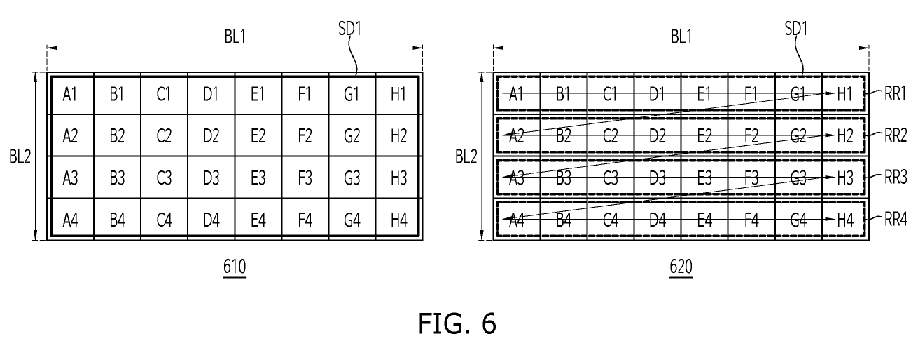

FIG. 6 illustrates an example in which read requests RR1 to RR4 are issued based on a structure of a sub-data set SD1 according to an embodiment of the present disclosure.

A first example 610 represents an example of any one sub-data set SD1 among a plurality of sub-data sets into which source data is divided. The sub-data set SD1 may include a plurality of data units arranged along a direction of a first axis and a direction of a second axis of the source data. A length of the sub-data set SD1 in the direction of the first axis may be determined as a first burst length BL1, and a length in the direction of the second axis may be determined as a second burst length BL2.

Referring to a second example 620, a DMA controller (e.g., the DMA controller 110 of FIG. 1) may issue read requests RR1 to RR4 for the source data based on the structure of the sub-data set SD1. The DMA controller may issue the read requests RR1 to RR4 in units of the first burst length BL1 for the sub-data set SD1. For example, the DMA controller may issue a first read request RR1 for a plurality of data units (e.g., A1, B1, C1, D1, E1, F1, G1, and H1) included in a first row (e.g., a first row according to the direction of the first axis) of the sub-data set SD1, and issue a second read request RR2 for a plurality of data units (e.g., A2, B2, C2, D2, E2, F2, G2, and H2) included in a second row.

By this configuration, the DMA controller issues a read request in units of a burst length optimized for the source data (e.g., the first burst length BL1) for the plurality of sub-data sets obtained by dividing the source data, thereby effectively utilizing a bandwidth of a memory device (e.g., the memory device 130 of FIG. 1) required for reading the source data.

Additionally, the DMA controller may convert a data structure so that the received plurality of sub-data sets may be stored in a form optimized for recording of destination data, for example, in units of the second burst length BL2. A description thereof will be described later with reference to FIGS. 7 and 8.

FIG. 7 illustrates an example in which a sub-data set SD1 is stored in a buffer group and then written as destination data according to an embodiment of the present disclosure.

A DMA controller (e.g., the DMA controller 110 of FIG. 1) may include a plurality of buffer groups. Each of a plurality of sub-data sets into which source data is divided may be stored in the plurality of buffer groups. For example, a first sub-data set SD1 may be stored in a first buffer group 700, and a second sub-data set may be stored in a second buffer group. A number of buffer groups may be at least 4, but is not limited thereto. Also, the plurality of buffer groups may be implemented in any volatile memory device, for example, may be implemented in static random access memory (SRAM), dynamic random access memory (DRAM), etc., but is not limited thereto.

Each of the plurality of buffer groups may include a plurality of buffers. Each of a plurality of data units included in the first sub-data set SD1 may be stored in each of a plurality of buffers included in the first buffer group 700. Each of the plurality of buffers may have a size (e.g., 128 bytes) corresponding to each of the plurality of data units, but is not limited thereto. For example, when the plurality of buffer groups are implemented as SRAM, the buffer group may refer to a physical part of the SRAM, for example, an SRAM slice, and the buffer may refer to a data unit stored in the SRAM.

A first example 710 is an example in which the plurality of data units included in the first sub-data set SD1 are stored in the first buffer group 700. The DMA controller may issue read requests RR1 to RR4 in units of a first burst length BL1 for the first sub-data set SD1. Based on the read requests RR1 to RR4 issued in this way, the DMA controller may receive the plurality of data units included in the first sub-data set SD1 from a memory device (e.g., the memory device 130 of FIG. 1). The plurality of data units included in the received first sub-data set SD1 may be stored in the plurality of buffers of the first buffer group 700, respectively.

In an embodiment, the DMA controller may identify an index of each of the plurality of buffers for storing each of the plurality of data units included in the first sub-data set SD1. At this time, the index of each of the plurality of buffers may be associated with an order in which write requests WR1 to WR8 are issued for the plurality of data units stored in the first buffer group 700. For example, the index of each of the plurality of buffers may be determined based on an arrangement order of the plurality of data units for issuing the write requests WR1 to WR8 in units of a second burst length BL2 for the plurality of data units stored in the first buffer group 700. This will be described with a specific example in the second example 720.

The second example 720 is an example in which the write requests WR1 to WR8 are issued for the plurality of data units of the first sub-data set SD1 stored in the first buffer group 700. The write requests WR1 to WR8 may be issued after all of the plurality of data units included in the first sub-data set SD1 have been completely stored in the first buffer group 700. For example, the DMA controller may determine whether the plurality of data units included in the first sub-data set SD1 have been completely stored in the first buffer group 700. In response to determining that the plurality of data units included in the first sub-data set SD1 have been completely stored in the first buffer group 700, the DMA controller may issue the write requests WR1 to WR8 for the plurality of data units stored in the first buffer group 700.

In an embodiment, the DMA controller may issue the continuous write requests WR1 to WR8 in units of the second burst length BL2 for the plurality of data units stored in the first buffer group 700. As a specific example, the DMA controller may issue a first write request WR1 for a plurality of data units A1 to A4 stored in BUF 1 to BUF 4, respectively, and issue a second write request WR2 for a plurality of data units B1 to B4 stored in BUF 5 to BUF 8.

That is, as each of the plurality of data units included in the first sub-data set SD1 is stored based on a predetermined index of each of the plurality of buffers, the DMA controller may issue the continuous write requests WR1 to WR8 in units of the second burst length BL2. In other words, the index of each of the plurality of buffers in which each of the plurality of data units included in the first sub-data set SD1 is stored may have been calculated in reverse based on an order of data units for which the write requests WR1 to WR8 are subsequently issued by the DMA controller.

By this configuration, the DMA controller stores the sub-data set in a buffer so that a write request in units of a burst length optimized for destination data (e.g., the second burst length BL2) may be continuously issued, thereby preventing a bandwidth of the memory device from being inefficiently used due to frequent memory access of a short burst length.

Also, as a length of the first sub-data set SD1 in a direction of a first axis (e.g., a horizontal direction) is determined as the first burst length BL1 and a length in a direction of a second axis is determined as the second burst length BL2, a length and a frequency of the read requests RR1 to RR4 and the write requests WR1 to WR8 for the plurality of data units included in the first sub-data set SD1 may be optimized. As a specific example, for the plurality of data units included in the first sub-data set SD1, a read request of the first burst length BL1 may be issued as many times as a number (e.g., 4) of data units included in the second burst length BL2, and a write request of the second burst length BL2 may be issued as many times as a number (e.g., 8) of data units included in the first burst length BL1.

FIG. 8 illustrates an example in which a sub-data set SD1 is stored in a buffer group and then written as destination data according to another embodiment of the present disclosure.

A first example 810 is an example in which a plurality of data units included in a first sub-data set SD1 are stored in a first buffer group 800. A DMA controller (e.g., the DMA controller 110 of FIG. 1) may issue read requests RR1 to RR4 in units of a first burst length BL1 for the first sub-data set SD1. Thereafter, a plurality of data units corresponding to the issued read requests RR1 to RR4 may be received from a memory device (e.g., the memory device 130 of FIG. 1). The plurality of data units included in the received first sub-data set SD1 may be stored in a plurality of buffers of the first buffer group 800, respectively.

In an embodiment, the DMA controller may sequentially store each of the plurality of data units included in the first sub-data set SD1 in the plurality of buffers of the first buffer group 800. As a specific example, data units of a plurality of data units A1, B1, C1, D1, E1, F1, G1, and H1 read by a first read request RR1 may be stored in BUF 1 to BUF 8, respectively.

A second example 820 is an example in which write requests WR1 to WR8 are issued for the plurality of data units of the first sub-data set SD1 stored in the first buffer group 800. With respect to the plurality of data units stored in the first buffer group 800, the DMA controller may identify an index of each of a plurality of buffers in which each of a plurality of data units for issuing the write requests WR1 to WR8 is stored. As a specific example, the DMA controller may identify an index of a buffer in which each of a plurality of data units A1, A2, A3, and A4 for issuing a first write request WR1 is stored. Also, the DMA controller may issue the write requests WR1 to WR8 for the plurality of data units stored in the first buffer group 800 based on the identified index of each of the plurality of buffers.

FIG. 9 is a diagram illustrating a memory system 900 including a DMA controller 910 according to an embodiment of the present disclosure. The memory system 900 may include the DMA controller 910 and a memory device 930 connected to the DMA controller 910. The memory device 930 may include a memory controller 932 and a memory 934. In the present embodiment, the DMA controller 910 may be implemented as hardware separate from the memory device 930. The memory 934 includes at least one memory, and the memory controller 932 may include at least one controller corresponding to the at least one memory, or may include one controller corresponding to the at least one memory. Here, the memory system 900 may correspond to the memory system 100 of FIG. 1.

The DMA controller 910 may be connected to the memory device 930 (e.g., the memory controller 932) through a plurality of channels 940_1 to 940_n (where n is a natural number greater than or equal to 2). Each of the plurality of channels 940_1 to 940_n may include a data channel for transmitting and receiving data, and a control channel for transmitting and receiving a request and/or a control signal, etc.

The DMA controller 910 may include a channel controller group 920. The channel controller group 920 may include a plurality of channel controllers 920_1 to 920_n. Each of the plurality of channel controllers 920_1 to 920_n may be a controller associated with each of the plurality of channels 940_1 to 940_n.

Each of the plurality of channel controllers 920_1 to 920_n may include a control logic 922, an address calculator 924, and a buffer group 926. The buffer group 926 may include a plurality of buffers BUF 1 to BUF M, where M may be a natural number greater than or equal to 2.

In the present embodiment, the control logic 922 and the address calculator 924 are illustrated as separate components, but are not limited thereto, and the address calculator 924 may be included in the control logic 922. The control logic 922 may generate a read request for reading data stored in the memory device 930 and/or a write request for writing data to the memory device 930. The address calculator 924 may calculate an address within the memory device 930 where data to be read is stored and/or an address of a specific region within the memory device 930 for writing data.

The DMA controller 910 may receive a task associated with an operation of converting a data structure of source data stored in the memory device 930 into a data structure of destination data. The channel controller group 920 may read the source data from the memory device 930 (or the memory controller 932) and write the destination data obtained by converting the data structure of the received source data to a destination region within the memory 934.

The channel controller group 920 may receive a plurality of sub-data sets into which the source data is divided from the memory device 930. The channel controller group 920 may receive the plurality of sub-data sets through the plurality of channels 940_1 to 940_n. For example, a first sub-data set may be received by a first channel controller 920_1 through a first channel 940_1, and a second sub-data set may be received by a second channel controller through a second channel 940_2.

In an embodiment, an operation in which the plurality of sub-data sets are received by the channel controller group 920 may be performed in parallel. For example, while the first channel controller 920_1 receives the first sub-data set through the first channel 940_1, the second channel controller may receive the second sub-data set through the second channel 940_2.

Each of the plurality of sub-data sets may be stored in a buffer group included in each of the plurality of channel controllers included in the channel controller group 920. For example, the first sub-data set may be stored in the buffer group 926 included in the first channel controller 920_1, and the second sub-data set may be stored in a buffer group included in the second channel controller.

The sub-data sets stored in the buffer groups may be converted into the data structure of the destination data and written to the memory device 930. For example, the DMA controller 910 may issue a write command for converting the plurality of sub-data sets stored in the respective buffer groups of the channel controllers 920_1 to 920_n, into the data structure of the destination data and writing them to the memory device 930.

In an embodiment, an operation of writing a specific sub-data set to the memory device 930 may be initiated after the specific sub-data set has been completely stored in a corresponding channel controller. For example, an operation of writing the first sub-data set to the memory device 930 may be initiated after the first sub-data set has been completely stored in the buffer group 926 of the first channel controller 920_1.

In an embodiment, an operation of writing the plurality of sub-data sets to the memory device 930 may be performed in parallel. For example, while the first channel controller 920_1 converts the first sub-data set into the data structure of the destination data and writes it to the destination region of the memory device 930 through the first channel 940_1, the second channel controller may convert the second sub-data set into the data structure of the destination data and write it to the destination region of the memory device 930 through the second channel 940_2.

In an example, while the first sub-data set is written to the memory device 930 with the data structure of the destination data through the first channel 940_1, the second sub-data set may be received from the memory device 930 through the second channel 940_2. Through this, as the data read operation and/or write operation are performed in parallel, data processing efficiency may increase.

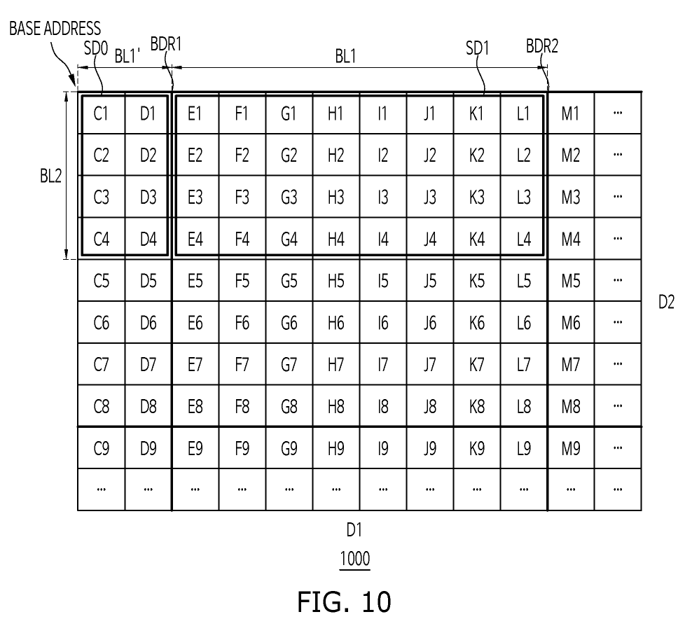

FIG. 10 illustrates an example in which a structure of a first sub-data set SD0 is defined. Source data 1000 may be stored in a specific region of a memory device (e.g., the memory device 130 of FIG. 1). A first burst length BL1, which is an optimized burst length of the source data 1000, may be determined based on a location of the specific region within the memory device where the source data 1000 is stored and/or a structure of the memory device.

The memory device may include boundaries at regular intervals. The specific region of the memory device where the source data 1000 is stored may have a boundary of a period of the first burst length BL1. For example, for data stored between a first boundary BDR 1 and a second boundary BDR 2 which is a next boundary, a continuous read operation or write operation in units of the first burst length BL1 may be possible.

A DMA controller (e.g., the DMA controller 110 of FIG. 1) may identify a base address of the specific region where the source data 1000 is stored in order to define a structure of a plurality of sub-data sets dividing the source data 1000. Also, the DMA controller may determine whether the identified base address is aligned with the boundary of the specific region where the source data 1000 is stored.

When it is determined that the base address is not aligned with the boundary, the DMA controller may define a structure of a first sub-data set SD0. The first sub-data set SD0 may be a sub-data set associated with a read request issued first among the plurality of sub-data sets. The data structure of the first sub-data set SD0 may be defined based on a burst length (e.g., BL1') shorter than the first burst length BL1 so that a subsequently defined sub-data set SD1 may be aligned with the first boundary BDR1.

Alternatively, the data structure of the first sub-data set SD0 may be defined based on a burst length (e.g., BL1' + BL1) longer than the first burst length BL1 so that the subsequently defined sub-data set SD1 may be aligned with the second boundary BDR2. The data structure of the first sub-data set SD0 may be changed based on a size of a buffer group for storing the first sub-data set SD0, a structure of a destination region within the memory device for writing the first sub-data set SD0, etc.

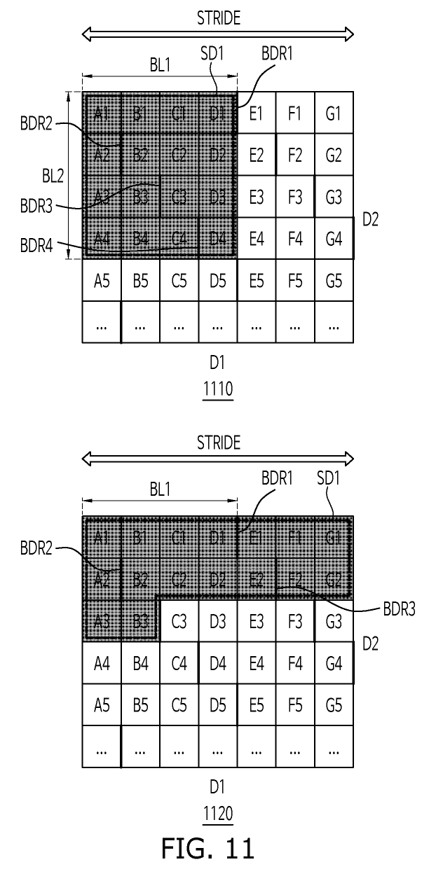

FIG. 11 illustrates an example in which a structure of a sub-data set SD1 is defined according to another embodiment of the present disclosure. A DMA controller (e.g., the DMA controller 110 of FIG. 1) may determine whether a stride of source data is a multiple of a first burst length BL1, which is an optimized burst length of the source data, in order to define a structure of a plurality of sub-data sets dividing the source data. In other words, the DMA controller may determine whether a number of a plurality of data units arranged in a direction of a first axis D1, which is a direction in which a read operation for the source data is performed, is a multiple of the first burst length BL1.

When the number of the plurality of data units arranged in the direction of the first axis D1 of the source data is not a multiple of the first burst length BL1, the DMA controller may define the structure of the plurality of sub-data sets such that a number of boundaries included within each of the plurality of sub-data sets is minimized.

A first example 1110 and a second example 1120 are examples of a case where the number of data units (e.g., 7) arranged in the direction of the first axis D1 of the source data is not a multiple of the first burst length BL1 (e.g., 4). In this case, boundaries within the source data are not aligned in units of the first burst length BL1, so it may be difficult to issue an optimized read request in units of the first burst length BL1. In this case, the DMA controller may define the structure of the sub-data set such that the number of boundaries included within each of the plurality of sub-data sets obtained by dividing the source data is minimized.

For example, comparing the structure of the sub-data set SD1 defined as in the first example 1110 and the structure of the sub-data set SD1 defined as in the second example 1120, the number of boundaries (4) included within the sub-data set SD1 in the first example 1110 becomes greater than the number of boundaries (3) included within the sub-data set SD1 in the second example 1120, so it may be more disadvantageous for issuing an optimized read request.

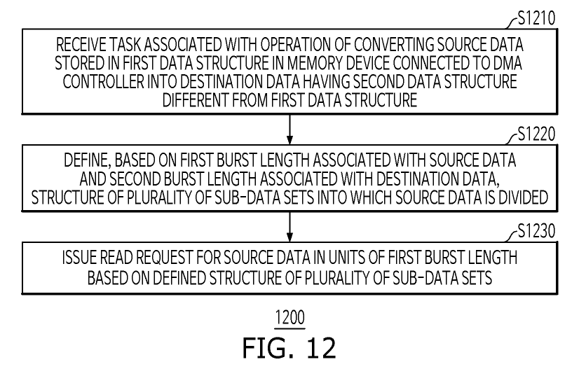

FIG. 12 is a flowchart illustrating a data processing method 1200 according to an embodiment of the present disclosure. The data processing method 1200 may be performed by a direct memory access (DMA) controller (e.g., the DMA controller 110 of FIG. 1) connected to a memory device (e.g., the memory device 130 of FIG. 1). The data processing method 1200 may be initiated by the DMA controller receiving a task associated with an operation of converting source data stored in a first data structure in the memory device connected to the DMA controller into destination data having a second data structure different from the first data structure (S1210). Here, the DMA controller may include a plurality of buffer groups, and each of the plurality of buffer groups may include a plurality of buffers. Each of the plurality of buffer groups may be connected to the memory device through a plurality of channels.

In an embodiment, each of the source data and the destination data may be a tensor including a plurality of data units of a multi-dimensional array. At this time, a plurality of data units included in the source data having the first data structure and a plurality of data units included in the destination data having the second data structure may have different axis arrangements. Also, the plurality of data units included in the source data may be processed in units of a first burst length, and the plurality of data units included in the destination data may be processed in units of a second burst length.

Thereafter, the DMA controller may define a structure of a plurality of sub-data sets into which the source data is divided based on the first burst length associated with the source data and the second burst length associated with the destination data (S1220). Here, each of the plurality of sub-data sets may include an array of a plurality of data units having a first axis and a second axis.

In an embodiment, a length of each of the plurality of sub-data sets in a direction of the first axis may be determined to be greater than or equal to the first burst length, and a length in a direction of the second axis may be determined to be greater than or equal to the second burst length. Also, the length of each of the plurality of sub-data sets in the direction of the first axis may be determined as a multiple of the first burst length, and the length in the direction of the second axis may be determined as a multiple of the second burst length.

In an embodiment, the source data may be stored in a specific region of the memory device. At this time, the specific region may include a boundary of a period of the first burst length. In this case, the DMA controller may identify a base address of the specific region in which the source data is stored in order to define the structure of the plurality of sub-data sets into which the source data is divided. Also, the DMA controller may determine whether the identified base address is aligned with the boundary. In response to determining that the identified base address is not aligned with the boundary, the DMA controller may define a structure of a first sub-data set. At this time, the first sub-data set may be a sub-data set associated with a read request issued first among the plurality of sub-data sets.

In another embodiment, the DMA controller may determine whether a number of a plurality of data units arranged in the direction of the first axis of the source data is a multiple of the first burst length in order to define the structure of the plurality of sub-data sets into which the source data is divided. In response to determining that the number of the plurality of data units arranged in the direction of the first axis is not a multiple of the first burst length, the DMA controller may define the structure of the plurality of sub-data sets such that a number of boundaries included within each of the plurality of sub-data sets is minimized.

Thereafter, the DMA controller may issue a read request for the source data in units of the first burst length based on the defined structure of the plurality of sub-data sets (S1230). Based on the issued read request, the DMA controller may receive the plurality of sub-data sets into which the source data is divided from the memory device through the plurality of channels. For example, the DMA controller may receive a first sub-data set through a first channel, and receive a second sub-data set through a second channel.

Thereafter, the DMA controller may store the received plurality of sub-data sets in the plurality of buffer groups. Also, the DMA controller may write the plurality of sub-data sets stored in each of the plurality of buffer groups to the memory device as the destination data having the second data structure.

For example, the DMA controller may store each of a plurality of data units included in the first sub-data set in a plurality of buffers included in a first buffer group. Also, the DMA controller may issue a write request for recording the plurality of data units stored in each of the plurality of buffers included in the buffer group into the second data structure. At this time, in order to issue the write request, the DMA controller may determine whether the plurality of data units included in the first sub-data set have been completely stored in the first buffer group. In response to determining that the plurality of data units included in the first sub-data set have been completely stored in the first buffer group, the DMA controller may issue the write request for the plurality of data units stored in the first buffer group.

As an example, the DMA controller may identify an index of each of the plurality of buffers for storing each of the plurality of data units included in the first sub-data set, and store the plurality of data units included in the first sub-data set in the first buffer group based on the identified index of each of the plurality of buffers. At this time, the identified index of each of the plurality of buffers may be associated with an order of the plurality of data units for which the write request is issued. The DMA controller may issue the write request in units of the second burst length for the plurality of data units stored in the first buffer group.

As another example, the DMA controller may sequentially store each of the plurality of data units included in the first sub-data set in the plurality of buffers. Also, the DMA controller may identify an index of each of the plurality of buffers in which each of a plurality of data units for issuing the write request is stored with respect to the first buffer group, and issue the write request for the plurality of data units stored in the first buffer group based on the identified index of each of the plurality of buffers.

The flowchart and description described above using FIG. 12 are only an example, and may be implemented differently in some embodiments. For example, in some embodiments, an order of each step may be changed, some steps may be performed repeatedly, some steps may be omitted, or some steps may be added.

The method described above may be provided as a computer program stored in a computer-readable recording medium for execution on a computer. The medium may continuously store a program executable by a computer, or may temporarily store it for execution or download. Also, the medium may be various recording means or storage means in a form in which a single or several hardware are combined, and is not limited to a medium directly connected to any computer system, but may be distributed on a network. Examples of the medium may include magnetic media such as hard disks, floppy disks, and magnetic tapes, optical recording media such as CD-ROMs and DVDs, magneto-optical media such as floptical disks, and media configured to store program instructions including ROM, RAM, flash memory, etc. Also, as examples of other media, there may be recording media or storage media managed by an app store distributing applications or sites, servers, etc. supplying or distributing other various software.

The methods, operations, or techniques of the present disclosure may be implemented by various means. For example, these techniques may be implemented by hardware, firmware, software, or a combination thereof. Those skilled in the art will understand that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design requirements imposed on the overall system. Those skilled in the art may implement the described functionality in various ways for each particular application, but such implementations should not be interpreted as causing a departure from the scope of the present disclosure.

In a hardware implementation, processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or a combination thereof.

Accordingly, various illustrative logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination of those designed to perform the functions described herein. A general-purpose processor may be a microprocessor, but in the alternative, the processor may be any conventional processor, controller, microcontroller, or state machine. The processor may also be implemented as a combination of computing devices, for example, a combination of a DSP and a microprocessor, a plurality of microprocessors, one or more microprocessors in conjunction with a DSP core, or any combination of any other configuration.

In a firmware and/or software implementation, the techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage device, etc. The instructions may be executable by one or more processors, and may cause the processor(s) to perform specific aspects of the functions described in the present disclosure.

When implemented in software, the techniques described above may be stored on a computer-readable medium or transmitted through a computer-readable medium as one or more instructions or code. Computer-readable media include both computer storage media and communication media including any medium that facilitates transfer of a computer program from one place to another. Storage media may be any available media that can be accessed by a computer. By way of non-limiting example, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source using wireless technologies such as coaxial cable, fiber optic cable, twisted pair, digital subscriber line (DSL), or infrared, radio, and microwave, then the coaxial cable, fiber optic cable, twisted pair, digital subscriber line, or wireless technologies such as infrared, radio, and microwave are included within the definition of the medium. As used herein, disk and disc include CD, laser disc, optical disc, digital versatile disc (DVD), floppy disk, and Blu-ray disc, where disks usually reproduce data magnetically, whereas discs reproduce data optically using lasers. Combinations of the above should also be included within the scope of computer-readable media.

A software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor can read information from, and write information to, the storage medium. Alternatively, the storage medium may be integrated into the processor. The processor and the storage medium may reside within an ASIC. The ASIC may reside within a user terminal. Alternatively, the processor and the storage medium may reside as separate components in the user terminal.

Although the embodiments described above have been described as utilizing aspects of the presently disclosed subject matter in one or more standalone computer systems, the present disclosure is not limited thereto, and may be implemented in conjunction with any computing environment such as a network or distributed computing environment. Furthermore, aspects of the subject matter in the present disclosure may be implemented in a plurality of processing chips or devices, and storage may be similarly effected across a plurality of devices. These devices may include PCs, network servers, and portable devices.

Although the present disclosure has been described in connection with some embodiments herein, various modifications and changes can be made without departing from the scope of the present disclosure understandable by those skilled in the art to which the invention of the present disclosure pertains. Also, such modifications and changes should be considered to fall within the scope of the claims appended hereto.

What is claimed is:

1. A data processing method performed by a direct memory access (DMA) controller, the data processing method comprising:
receiving a task associated with an operation of converting source data stored in a first data structure in a memory device connected to the DMA controller into destination data having a second data structure different from the first data structure;
defining, based on a first burst length associated with the source data and a second burst length associated with the destination data, a structure of a plurality of sub-data sets into which the source data is divided; and
issuing a read request for the source data in units of the first burst length based on the defined structure of the plurality of sub-data sets.

2. The data processing method as claimed in claim 1, wherein each of the source data and the destination data is a tensor comprising a plurality of data units of a multi-dimensional array, and
a plurality of data units included in the source data having the first data structure and a plurality of data units included in the destination data having the second data structure have different axis arrangements.

3. The data processing method as claimed in claim 2, wherein the plurality of data units included in the source data are processed in units of the first burst length, and
the plurality of data units included in the destination data are processed in units of the second burst length.

4. The data processing method as claimed in claim 3, wherein each of the plurality of sub-data sets comprises a plurality of data units arranged along a direction of a first axis of the tensor and a direction of a second axis of the tensor,
a length of each of the plurality of sub-data sets in the direction of the first axis is determined to be greater than or equal to the first burst length, and
a length of each of the plurality of sub-data sets in the direction of the second axis is determined to be greater than or equal to the second burst length.

5. The data processing method as claimed in claim 4, wherein the length of each of the plurality of sub-data sets in the direction of the first axis is determined as a multiple of the first burst length, and
the length of each of the plurality of sub-data sets in the direction of the second axis is determined as a multiple of the second burst length.

6. The data processing method as claimed in claim 3, wherein the DMA controller comprises a plurality of buffer groups,
each of the plurality of buffer groups comprises a plurality of buffers, and
the method further comprises:
receiving, based on the issued read request and from the memory device, the plurality of sub-data sets into which the source data is divided; and
storing the received plurality of sub-data sets in each of the plurality of buffer groups.

7. The data processing method as claimed in claim 6, further comprising writing the plurality of sub-data sets stored in each of the plurality of buffer groups to the memory device as the destination data having the second data structure.

8. The data processing method as claimed in claim 7, wherein the storing comprises storing each of a plurality of data units included in a first sub-data set in a plurality of buffers included in a first buffer group, and
the writing comprises issuing a write request for recording the plurality of data units stored in each of the plurality of buffers included in the first buffer group into the second data structure.

9. The data processing method as claimed in claim 8, wherein the storing in the plurality of buffers comprises:
identifying an index of each of the plurality of buffers for storing each of the plurality of data units included in the first sub-data set; and
storing, based on the identified index of each of the plurality of buffers, the plurality of data units included in the first sub-data set in the first buffer group,
wherein the issuing comprises issuing the write request in units of the second burst length for the plurality of data units stored in the first buffer group, and
the identified index of each of the plurality of buffers is associated with an order of the plurality of data units for which the write request is issued.

10. The data processing method as claimed in claim 8, wherein the storing in the plurality of buffers comprises sequentially storing each of the plurality of data units included in the first sub-data set in the plurality of buffers, and
the issuing comprises:
identifying an index of each of the plurality of buffers in which each of a plurality of data units for issuing the write request is stored, with respect to the first buffer group; and
issuing, based on the identified index of each of the plurality of buffers, the write request for the plurality of data units stored in the first buffer group.

11. The data processing method as claimed in claim 8, wherein the issuing comprises:
determining whether the plurality of data units included in the first sub-data set have been completely stored in the first buffer group; and
issuing the write request for the plurality of data units stored in the first buffer group in response to determining that the plurality of data units included in the first sub-data set have been completely stored in the first buffer group.

12. The data processing method as claimed in claim 6, wherein each of the plurality of buffer groups is connected to the memory device through a plurality of channels, and
the receiving comprises:
receiving a first sub-data set through a first channel; and
receiving a second sub-data set through a second channel.

13. The data processing method as claimed in claim 3, wherein the source data is stored in a specific region of the memory device,
the specific region comprises a boundary of a period of the first burst length,
the defining comprises:
identifying a base address of the specific region in which the source data is stored;
determining whether the identified base address is aligned with the boundary; and
defining a structure of a first sub-data set in response to determining that the identified base address is not aligned with the boundary, and
the first sub-data set is a sub-data set associated with a read request issued first among the plurality of sub-data sets.

14. The data processing method as claimed in claim 3, wherein the source data is stored in a specific region of the memory device,
the specific region comprises a boundary of a period of the first burst length,
the defining comprises:
determining whether a number of the plurality of data units arranged in the direction of the first axis of the source data is a multiple of the first burst length; and
in response to determining that the number of the plurality of data units arranged in the direction of the first axis is not a multiple of the first burst length, defining the structure of the plurality of sub-data sets such that a number of boundaries included within each of the plurality of sub-data sets is minimized.

15. A memory system comprising:
a DMA controller comprising a plurality of buffer groups; and
a memory device connected to the plurality of buffer groups through a plurality of channels,
wherein the DMA controller is configured to:
receive a task associated with an operation of converting source data stored in a first data structure in the memory device into destination data having a second data structure different from the first data structure,
define, based on a first burst length associated with the source data and a second burst length associated with the destination data, a structure of a plurality of sub-data sets into which the source data is divided, and
issue, based on the defined structure of the plurality of sub-data sets, a read request for the source data in units of the first burst length.

16. The memory system as claimed in claim 15, wherein each of the source data and the destination data is a tensor comprising a plurality of data units of a multi-dimensional array,
a plurality of data units included in the source data having the first data structure and a plurality of data units included in the destination data having the second data structure have different axis arrangements, and
the DMA controller is further configured to:
process the plurality of data units included in the source data in units of the first burst length, and
process the plurality of data units included in the destination data in units of the second burst length.

17. The memory system as claimed in claim 16, wherein each of the plurality of sub-data sets comprises a plurality of data units arranged along a direction of a first axis of the tensor and a direction of a second axis of the tensor,
a length of each of the plurality of sub-data sets in the direction of the first axis is determined as a multiple of the first burst length, and
a length of each of the plurality of sub-data sets in the direction of the second axis is determined as a multiple of the second burst length.

18. The memory system as claimed in claim 16, wherein the DMA controller is further configured to:
receive, from the memory device through the plurality of channels, the plurality of sub-data sets into which the source data is divided,
store the received plurality of sub-data sets in each of the plurality of buffer groups, and
write the plurality of sub-data sets stored in each of the plurality of buffer groups to the memory device as the destination data having the second data structure.

19. The memory system as claimed in claim 18, wherein each of the plurality of buffer groups comprises a plurality of buffers, and
the DMA controller is further configured to:
store each of a plurality of data units included in a first sub-data set in the plurality of buffers included in a first buffer group, and
issue a write request for recording the plurality of data units stored in each of the plurality of buffers included in the first buffer group into the second data structure.

20. The memory system as claimed in claim 19, wherein the DMA controller is further configured to:
identify an index of each of the plurality of buffers for storing each of the plurality of data units included in the first sub-data set;
store, based on the identified index of each of the plurality of buffers, the plurality of data units included in the first sub-data set in the first buffer group; and
issue the write request in units of the second burst length, for the plurality of data units stored in the first buffer group,
wherein the identified index of each of the plurality of buffers is associated with an order of the plurality of data units for which the write request is issued.
